(19) United States
(12) Patent Application Publication
(10) Pub. No.: US 2011/0048225 A1
(43) Pub. Date: Mar. 3, 2011

(54) CYLINDER APPARATUS

(76) Inventors: Tadashi YOSHIDA, Ebina-shi (JP); Masahiro Ashiba, Ninomiya-machi (JP)

(21) Appl. No.: 12/872,045

(22) Filed: Aug. 31, 2010

(30) Foreign Application Priority Data
Aug. 31, 2009 (JP) 200606/2009

(51) Int. Cl. F16F 9/36; F16F 9/19

(52) U.S. Cl. 92/142; 92/165 R; 92/169.1

(57) ABSTRACT

On a protrusion-formation portion of a rod guide, there are provided a first annular protrusion for supporting a radially outer side of a lid body and a second annular protrusion for supporting a radially inner side of the lid body. Accordingly, when an upper end side of an outer cylinder is caulked, the first annular protrusion provided to the rod guide is allowed to sandwich and fix the radially outer side of the lid body between the first annular protrusion and the caulked portion. Further, although the lid body is strongly pressed to the rod guide with use of a presser at the time of caulking the upper end side of the outer cylinder, a pressing force acting onto the lid body can be received by the second annular protrusion. As a result, the lid body is prevented from being permanently deformed. With this structure, the lid body can be formed to have a small thickness dimension.

### BACKGROUND OF THE INVENTION

The present invention relates to a cylinder apparatus, which is well suited when being used for reducing vibration of a vehicle such as an automobile.

As disclosed in JP 2002-257177 A, for example, vehicles such as automobiles are provided with a cylinder apparatus between a vehicle body and each of wheels. The cylinder apparatus serves to reduce the vibration generated during driving.

By the way, the cylinder apparatus is fixed in a narrow space between the vehicle body and the each of the wheels, and hence it is desired to reduce an axial dimension of the cylinder apparatus.

### SUMMARY OF THE INVENTION

It is an object of the present invention to provide a cylinder apparatus having a small axial dimension. In order to solve the above-mentioned problem, the feature of the structure of the present invention lies in that a rod guide has a surface, which faces a lid body and on which a first annular protrusion for supporting a radially outer side of the lid body and a second annular protrusion for supporting a radially inner side of the lid body are provided, the second annular protrusion being provided on the radially inner side relative to the first annular protrusion while being separated from the first annular protrusion.

### BRIEF DESCRIPTION OF THE DRAWINGS

In the accompanying drawings:

FIG. 1 is a vertical sectional view of a cylinder apparatus according to a first embodiment;

FIG. 2 is an enlarged vertical sectional view of a main portion, illustrating an upper part of the cylinder apparatus of FIG. 1 in an enlarged manner;

FIG. 3 is an enlarged vertical sectional view of a main portion, illustrating a portion “a” of FIG. 2;

FIG. 4 is a vertical sectional view illustrating only a rod guide according to the first embodiment in an enlarged manner;

FIG. 5 is a plan view of the rod guide of FIG. 4;

FIG. 6 is a vertical sectional view from the similar position to that of FIG. 2, illustrating a state in which a lid body is pressed with a presser for the purpose of caulking another end side (opening side) of an outer cylinder;

FIG. 7 is a vertical sectional view of a rod guide according to a second embodiment of the present invention;

FIG. 8 is a plan view of the rod guide of FIG. 7;

FIG. 9 is a vertical sectional view of a rod guide according to a third embodiment of the present invention;

FIG. 10 is a plan view of the rod guide of FIG. 9; and

FIG. 11 is an enlarged vertical sectional view of a main portion, illustrating a modification in which a caulked portion is longest.

### DETAILED DESCRIPTION OF THE INVENTION

In the following, detailed description is made of a cylinder apparatus according to embodiments of the present invention with reference to accompanying drawings.

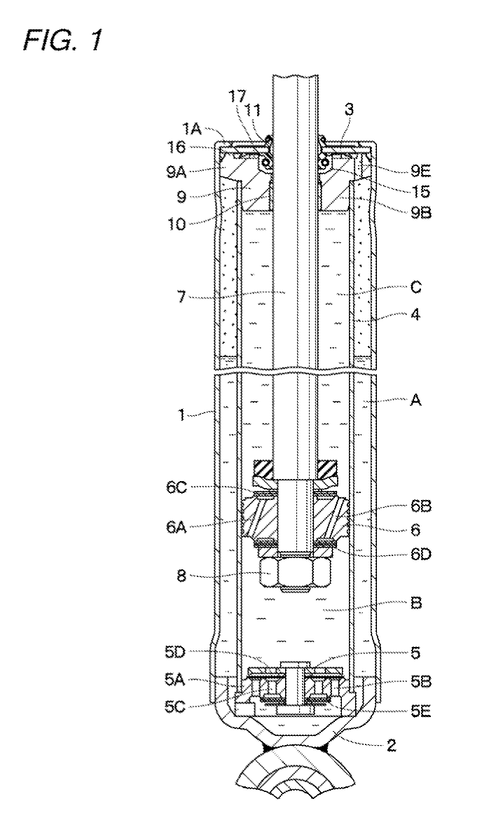

First, FIGS. 1 to 6 illustrate a first embodiment of the present invention. In FIG. 1, reference numeral 1 denotes a bottomed-cylindrical outer cylinder constituting an outer shape of a cylinder apparatus according to the first embodiment. The outer cylinder 1 is closed on a lower end side thereof corresponding to one end (first end portion) side with a bottom cap 2 welded thereto, and is open on an upper end side corresponding to another end (second end portion) side. Further, an upper end portion of the outer cylinder 1 is bent radially inward so as to constitute a caulked portion 1A.

In this context, the caulked portion 1A formed at the upper end portion of the outer cylinder 1 is arranged so that a position of a distal end portion 1A1 thereof, in other words, a radial position of a radially smallest part of the distal end portion reaches a first annular protrusion 16 described later. Specifically, in order to achieve weight reduction and cost reduction, the distal end portion 1A1 of the caulked portion 1A is arranged substantially at least at a position at which a radially outer side 3A of a lid body 3 may be sandwiched between the distal end portion 1A1 and the first annular protrusion 16. With this structure, the distal end portion 1A1 of the caulked portion 1A is prevented from interfering with a presser 19 for pressing the lid body 3 described later.

The reference numeral 3 denotes the lid body including an annular disk provided on the upper end side of the outer cylinder 1. The lid body 3 closes an opening on the upper end side of the outer cylinder 1. Further, the radially outer side 3A of the lid body 3 is fixed by caulking with the caulked portion 1A under a state of being held in contact with a rod guide 9 described later. Meanwhile, a rod seal 11 described later is provided on a radially inner side 3B of the lid body 3.

Reference numeral 4 denotes an inner cylinder coaxially provided in the outer cylinder 1. The inner cylinder 4 is fixed to an outer peripheral side of a bottom valve 5 described later with a lower end side thereof being fitted to the outer peripheral side of the bottom valve 5. Further, the inner cylinder 4 defines an annular reservoir chamber A between the inner cylinder 4 and the outer cylinder 1, the reservoir chamber A having oil liquid and gas sealed therein. The gas may be the air having a pressure equal to the atmospheric pressure or a compressed nitrogen gas.

The reference numeral 5 denotes the bottom valve provided between the bottom cap 2 and the inner cylinder 4 while being positioned on the lower end side of the inner cylinder 4. The bottom valve 5 generally includes: a valve body 5A which has a shape of a stepped disk fittingly fixed between the lower end side of the inner cylinder 4 and an upper surface of the bottom cap 2, and is provided with annular valve sheets formed on a front surface and a rear surface thereof; oil paths 5B and 5C provided in the valve body 5A; a check valve 5D provided on an upper surface side of the valve body 5A; and a disk valve 5E provided on a lower surface side of the valve body 5A.

In the bottom valve 5, when a piston rod 7 extends together with a piston 6, the disk valve 5E closes and the check valve 5D opens. In this manner, the oil liquid on a reservoir chamber A side is caused to flow into a bottom-side oil chamber B described later via the oil path 5B. Meanwhile, when the piston rod 7 retracts, the check valve 5D closes and the disk valve 5E opens. In this manner, the oil liquid on the bottom-side oil chamber B side is caused to flow into the reservoir chamber A. In this case, the disk valve 5E causes fluid resistance with respect to the oil liquid flowing through the oil path 5C so as to generate a damping force.

The reference numeral 6 denotes the piston fit-inserted so as to be slidable in the inner cylinder 4. The piston 6 partitions an inside of the inner cylinder 4 into the bottom-side oil chamber B and a rod-side oil chamber C. Further, the piston 6 is provided with oil paths 6A and 6B formed therein capable of communicating the bottom-side oil chamber B and the rod-side oil chamber C to each other. In addition, on an upper end surface of the piston 6, a retraction-side disk valve 6C is arranged which causes a resistance force, when retraction of the piston rod 7 causes the piston 6 to be slidingly displaced downward, with respect to the oil liquid flowing through the oil path 6A so as to generate a predetermined damping force. Further, on a lower end surface of the piston 6, an extension-side disk valve 6D is arranged which causes a resistance force, when extension of the piston rod 7 causes the piston 6 to be slidingly displaced upward, with respect to the oil liquid flowing through the oil path 6B so as to generate a predetermined damping force.

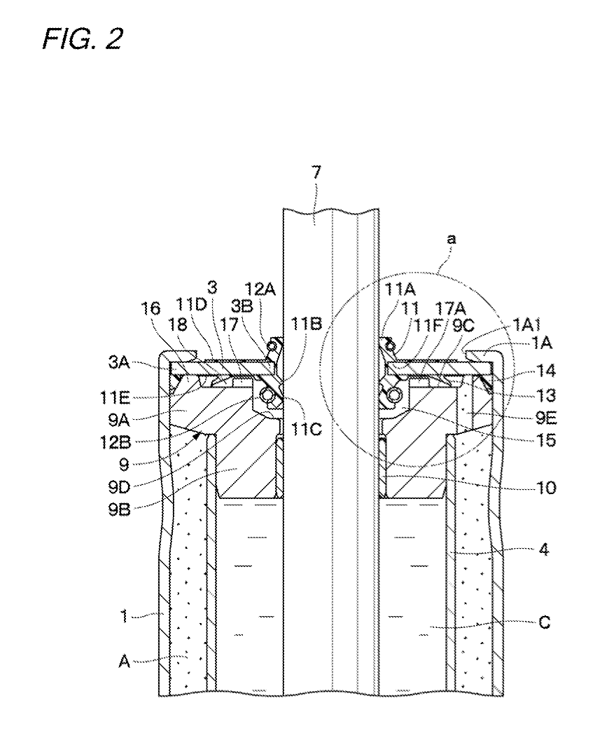

The reference numeral 7 denotes the piston rod. The piston rod 7 is inserted on a lower end side thereof into the inner cylinder 4 and firmly fixed to an inner peripheral side of the piston 6 with a nut 8, and the like. Further, as illustrated in FIG. 2, the piston rod 7 protrudes on an upper end side thereof to an outside through, for example, the rod guide 9 described later and the lid body 3.

Reference numeral 9 denotes the cylindrical rod guide provided on an upper end side of the inner cylinder 4. The rod guide 9 positions an upper part of the inner cylinder 4 to a center of the outer cylinder 1 and guides the piston rod 7 in the axial direction on an inner peripheral side thereof. Further, the rod guide 9 serves as a supporting structure for supporting the lid body 3 from inside when the lid body 3 is fixed from outside with caulking by the caulked portion 1A of the outer cylinder 1. In addition, the rod guide 9 is formed in a predetermined shape with use of, for example, a metal material or a hard resin material subjected to a molding process, a trimming process, or the like.

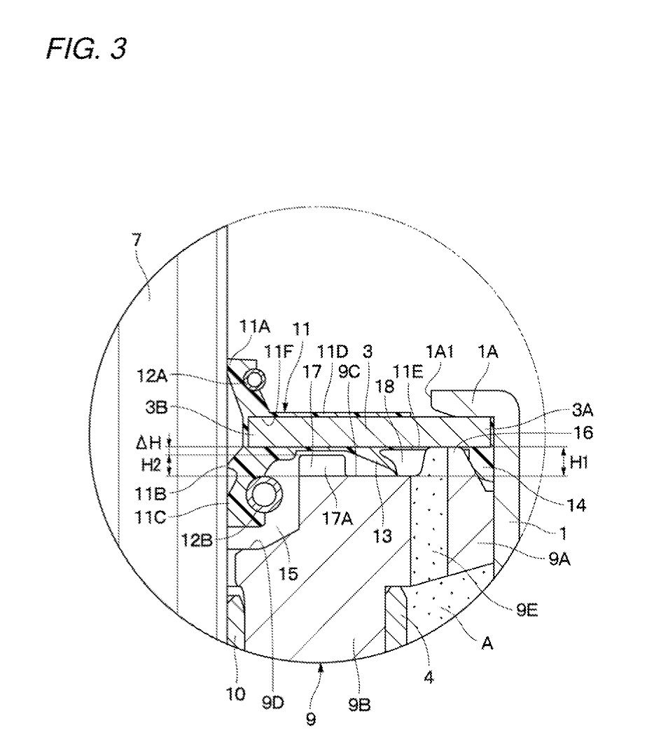

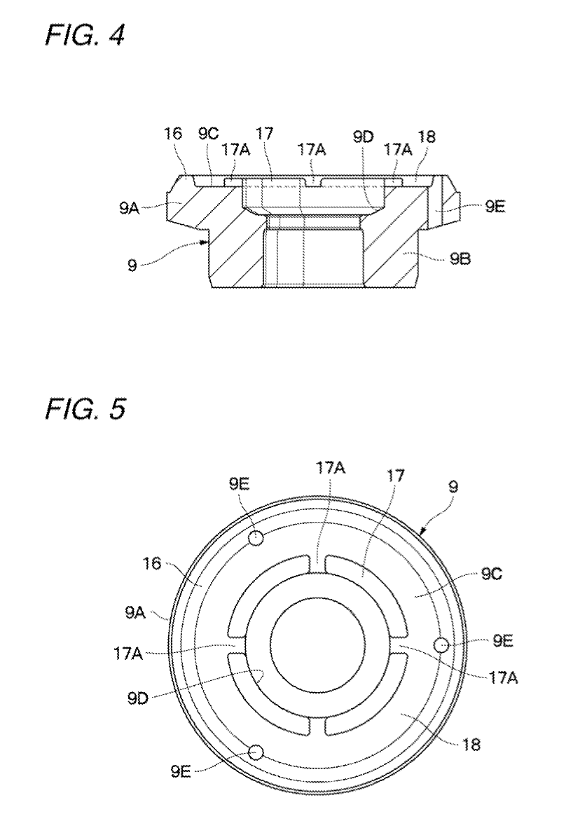

As illustrated in FIGS. 3 and 4, the rod guide 9 is formed in a stepped cylindrical shape by a large diameter portion 9A positioned on an upper side thereof and fit-inserted on an inner peripheral side of the outer cylinder 1 and by a small diameter portion 9B positioned on a lower side thereof and fit-inserted on an inner peripheral side of the inner cylinder 4. A guide portion 10 for slidably guiding the piston rod 7 in the axial direction is provided on an inner peripheral side of the small diameter portion 9B. The guide portion 10 is constituted by an inner peripheral surface of a metal cylinder which is coated with tetrafluoroethylene.

Further, an upper end surface of the large diameter portion 9A, which faces the lid body 3 constitutes a substantially flat protrusion-formation portion 9C having an annular shape. On the protrusion-formation portion 9C, the first annular protrusion 16 and a second annular protrusion 17, which are described later, are formed in a manner of forming concentric circles. Still further, on a radially inner side of the protrusion-formation portion 9C, which inner side corresponds to an upper side of the small diameter portion 9B, a recessed portion 9D is formed in a manner of recessing a radially inner side of the large diameter portion 9A in the axial direction. The recessed portion 9D accommodates lower lip portions 11B and 11C of the rod seal 11 described later, and constitutes a periphery and lower side surface of an oil storage chamber 15.

In addition, a first communication path 9E is provided on a radially outer side of the large diameter portion 9A. The first communication path 9E is arranged at a plurality of points separated from each other in a circumferential direction at, for example, three points, that is, formed as communication holes passing through the large diameter portion 9A in the axial direction. As a result, the first communication paths 9E communicate the reservoir chamber A and an annular space 18 described later to each other.

The rod guide 9 having the above-mentioned structure is fixed, with the large diameter portion 9A being press-fitted onto an inner peripheral side of the outer cylinder 1 and the small diameter portion 9B being press-fitted onto the inner peripheral side of the inner cylinder 4. In this state, the rod guide 9 guides the piston rod 7 in the axial direction along the guide portion 10 provided on the inner peripheral side thereof.

Reference numeral 11 denotes the rod seal provided on the radially inner side of the lid body 3. The rod seal 11 is formed in a stepped cylindrical shape with use of, for example, an elastic material such as nitrile rubber, and held in sliding contact with an outer peripheral side of the piston rod 7 so as to effect sealing between the lid body 3 and the piston rod 7. Further, as illustrated in FIG. 3, on an radially inner side of the rod seal 11, an upper lip portion 11A is provided at an upper position of the lid body 3 in a manner of protruding to the outside, and the two lower lip portions 11B and 11C are provided above and below separately from each other at a lower position of the lid body 3 in a manner of intruding into the outer cylinder 1.

Further, the rod seal 11 is provided with the following formed integrally with and facing each other: an upper annular-plate portion 11D extending radially outward from a proximal end portion of the upper lip portion 11A along an upper surface of the lid body 3; and a lower annular-plate portion 11E extending radially outward from proximal end portions of the lower lip portions 11B and 11C along a lower surface of the lid body 3. A fixing recessed groove 11F is formed between the annular-plate portions 11D and 11E, the fixing recessed groove 11F being firmly fixed in a fit state onto the radially inner side of the lid body 3 by a firm fixing means such as welding or bonding.

The lower annular-plate portion 11E of the rod seal 11 extends to the radially outer side 3A of the lid body 3. A lip seal 13 and seal ring 14 described later are formed integrally with a radially midway part and radially outermost portion of the lower annular-plate portion 11E, respectively.

The rod seal 11 brings the upper lip portion 11A into sliding contact with the outer peripheral side of the piston rod 7 through intermediation of a ring-shaped pressing spring 12A with a tightening margin, and brings the lower lip portions 11B and 11C into sliding contact with the outer peripheral side of the piston rod 7 through intermediation of a pressing spring 12B with a tightening margin. In this manner, sealing is effected between the rod seal 11 and the piston rod 7 in an air-tight and liquid-tight manner.

Reference numeral 13 denotes the lip seal formed integrally with the rod seal 11 and serving as a check valve. Similarly to the rod seal 11, the lip seal 13 is formed with use of an elastic material such as rubber. Further, the lip seal 13 is firmly fixed on a proximal end side thereof to the radially midway position of the lower annular-plate portion 11E constituting the rod seal 11 and extends on a distal end side thereof obliquely downward and radially outward. Still further, the lip seal 13 is arranged in the annular space 18 between the annular protrusions 16 and 17 described later. At this position, a distal end portion of the lip seal 13 is held in contact with the protrusion-formation portion 9C of the rod guide 9 with a tightening margin.

The lip seal 13 is arranged between the oil storage chamber 15 described later and the reservoir chamber A, and allows the oil liquid in the oil storage chamber 15 to flow into the reservoir chamber A through the annular space 18 and the communication paths 9E of the rod guide 9. In this manner, a reverse flow is prevented, that is, the gas and the oil liquid in the reservoir chamber A is prevented from flowing toward the oil storage chamber 15.

Further, reference numeral 14 denotes the seal ring positioned on the radially outer side 3A of the lid body 3 and formed integrally with the rod seal 11. The seal ring 14 prevents the gas and the oil liquid in the reservoir chamber A from leaking out to the outside from between the outer cylinder 1 and the lid body 3.

Reference numeral 15 denotes the oil storage chamber provided between the rod guide 9 and the rod seal 11. The oil storage chamber 15 is formed as an annular space portion surrounded by the piston rod 7, the recessed portion 9D of the rod guide 9, and the lower lip portion 11B of the rod seal 11. Further, when the oil liquid in the rod-side oil chamber C or gas mixed into the oil liquid leaks out through, for example, a small gap between the piston rod 7 and the guide portion 10, the oil storage chamber 15 temporarily stores the leaked oil liquid, and the like.

Reference numeral 16 denotes the first annular protrusion. The first annular protrusion. 16 is provided on a radially outer side of the protrusion-formation portion 9C of the rod guide 9 correspondingly to the caulked portion 1A of the outer cylinder 1. Further, as illustrated in FIG. 3, the first annular protrusion 16 supports the radially outer side 3A of the lid body 3, and is formed, as an annular protrusion provided so as to protrude to the lid body 3 and having a trapezoidal shape in cross-section, integrally with the protrusion-formation portion 9C of the rod guide 9. Still further, a length dimension (height dimension) in the axial direction of the first annular protrusion 16 is a dimension H1 larger (higher) than a length dimension (height dimension) H2 in the axial direction of the second annular protrusion 17 described later.

With this structure, when the another end side (opening side) of the outer cylinder 1 is subjected to a caulking process, the radially outer side 3A of the lid body 3 can be sandwiched and fixed between the first annular protrusion 16 and the caulked portion 1A of the outer cylinder 1. Further, the first annular protrusion 16 is formed to be longer than the second annular protrusion 17. Thus, when the rod guide 9 is pressed from inside, a load applied in this case can be supported with the caulked portion 1A of the outer cylinder 1 as a high-strength member through intermediation of the lid body 3.

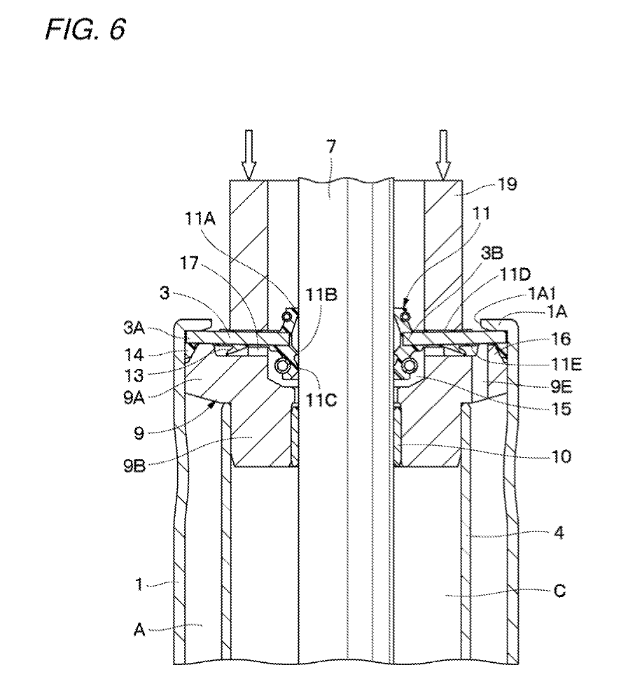

Reference numeral 17 denotes the second annular protrusion provided on the radially inner side of the protrusion-formation portion 9C of the rod guide 9. The second annular protrusion 17 is provided on the radially inner side relative to the first annular protrusion 16 while being separated therefrom so as to face the presser 19 at the time of manufacture described later. Further, as illustrated in FIG. 6, the second annular protrusion 17 supports the radially inner side 3B of the lid body 3 when the lid body 3 is pressed from above with the presser 19 described later. Further, as illustrated in FIG. 3, the second annular protrusion 17 is formed, as an annular protrusion provided so as to protrude to the lid body 3 and having a rectangular shape in axial cross-section, integrally with the protrusion-formation portion 9C of the rod guide 9.

Meanwhile, the second annular protrusion 17 is positioned adjacent to the recessed portion 9D, that is, arranged at a radially innermost position of the protrusion-formation portion 9C. With this structure, the second annular protrusion 17 is allowed to reliably support the radially inner side 3B of the lid body 3.

Further, the length dimension in the axial direction of the second annular protrusion 17 is the dimension H2 smaller than the above-mentioned length dimension H1 in the axial direction of the first annular protrusion 16. In this context, a dimensional difference ΔH between the length dimension H1 of the first annular protrusion 16 and the length dimension H2 of the second annular protrusion 17 is set to a dimension so that, when the radially inner side 3B of the lid body 3 is pressed downward by the presser 19, a distal end surface of the second annular protrusion 17 can be brought into contact with the lid body 3 within a range of elastic deformation of the lid body 3.

Further, the second annular protrusion 17 formed integrally with the rod guide 9 is provided with second communication paths 17A at, for example, four points in the circumferential direction. The second communication paths 17A are formed as communication paths formed by cutting out of the second annular protrusion 17 in a radial direction. In this case, the second communication paths 17A communicate the oil storage chamber 15 and the annular space 18 described later to each other.

Reference numeral 18 denotes the annular space provided between the first annular protrusion 16 and the second annular protrusion 17. The annular space 18 is formed as a circular space communicating the first communication paths 9E of the rod guide 9 and the second communication paths 17A of the second annular protrusion 17 to each other. Further, the lip seal 13 is arranged in the annular space 18.

The cylinder apparatus according to the first embodiment is configured as described above. Next, description is made of procedures of fixing the rod guide 9, the lid body 3, and the like onto the upper end side of the outer cylinder 1.

First, the large diameter portion 9A and small diameter portion 9B of the rod guide are press-fitted to the outer cylinder 1 and the inner cylinder 4, respectively. Then, the lid body 3 to which the rod seal 11, the lip seal 13, and the like are fixed is arranged on the upper side of the rod guide 9. Next, as illustrated in FIG. 6, in order to prevent backlash of the rod guide 9 in the axial direction, the rod guide 9 is pressed with the cylindrical presser 19 against the inner cylinder 4 through intermediation of the lid body 3. In this state, when the upper end portion of the outer cylinder 1 is bent radially inward, the radially outer side 3A of the lid body 3 and the large diameter portion 9A of the rod guide 9 can be fixed with the caulked portion 1A.

In this case, when the lid body 3 is pressed with the presser 19, the second annular protrusion 17 provided to the rod guide 9 supports the radially inner side 3B of the lid body 3 from below so as to prevent excessive deformation of the lid body 3.

Next, after the cylinder apparatus is assembled, the upper end side of the piston rod 7 is fixed onto a vehicle body side of an automobile, and the lower end side of the outer cylinder 1 is fixed onto an axle side (none of which are shown). With this structure, when vibration occurs during driving of the automobile, a damping force is generated by, for example, the disk valves 6C and 6D of the piston 6 while the piston rod 7 is extended and retracted, whereby the vibration during driving is damped by the damping force.

That is, when the piston rod 7 is on an extension process, pressure in the rod-side oil chamber C becomes higher. Thus, pressure oil in the rod-side oil chamber C flows into the bottom-side oil chamber B through the disk valve 6D, and the damping force is generated. Then, oil liquid of an amount corresponding to a moving-out volume of the piston rod 7 having moved out from the inner cylinder 4 flows from inside the reservoir chamber A into the bottom-side oil chamber B through the check valve 5D of the bottom valve 5.

Then, the pressure in the rod-side oil chamber C becomes higher in this case, and hence the oil liquid in the rod-side oil chamber C leaks out into the oil storage chamber 15 in some cases through, for example, the small gap between the piston rod 7 and the guide portion 10. Further, when an amount of the leakage oil increases in the oil storage chamber 15, the oil liquid having overflown flows from the second communication paths 17A into the annular space 18, and is caused to flow back into the reservoir chamber A through the first communication paths 9E while the lip seal 13 is opened.

Further, when the pressure in the rod-side oil chamber C becomes higher, inner pressure acts in a direction of moving the rod guide 9 upward. In this case, the first annular protrusion 16 provided on a radially outer side of the rod guide 9 is capable of causing the load applied by the pressure in this case to be supported with the caulked portion 1A of the outer cylinder 1 as a high-strength member through intermediation of the lid body 3.

Meanwhile, when the piston rod 7 is on a retraction process, pressure in the bottom-side oil chamber B becomes higher. Thus, pressure oil in the bottom-side oil chamber B flows into the rod-side oil chamber C through the disk valve 6C, and the damping force is generated. Then, oil liquid of an amount corresponding to a moving-in volume of the piston rod 7 having moved into the inner cylinder 4 flows from the bottom-side oil chamber B into the reservoir chamber A through the disk valve 5E of the bottom valve 5. As a result, the moving-in volume of the piston rod 7 is absorbed.

As described above, according to the first embodiment, the protrusion-formation portion 9C of the rod guide 9 is provided with the first annular protrusion 16 for supporting the radially outer side 3A of the lid body 3 and the second annular protrusion 17 for supporting the radially inner side 3B of the lid body 3, the first annular protrusion 16 and the second annular protrusion 17 being provided at the position corresponding to the caulked portion 1A of the outer cylinder 1 and at the separate position on the radially inner side relative to the first annular protrusion 16, respectively. Accordingly, when the upper end side of the outer cylinder 1 is caulked, the first annular protrusion 16 provided to the rod guide 9 is allowed to sandwich and fix the radially outer side 3A of the lid body 3 between the first annular protrusion 16 and the caulked portion 1A of the outer cylinder 1.

In addition, although the lid body 3 is strongly pressed to the rod guide 9 with use of the presser 19 at the time of caulking the upper end side of the outer cylinder 1, the pressing force acting onto the lid body 3 in this case can be received by the second annular protrusion 17 provided to the rod guide 9. As a result, the radially inner side 3B of the lid body 3 is prevented from being permanently deformed.

Further, the distal end portion 1A1 of the caulked portion 1A formed by a caulking process is arranged on the radially outer side relative to the second annular protrusion 17. Thus, the distal end portion 1A1 of the caulked portion 1A is prevented from interfering with the presser 19.

As a result, the lid body 3 provided on the upper end side of the outer cylinder 1 can be formed to have a small thickness dimension. Accordingly, the axial dimension of the cylinder apparatus can be reduced correspondingly to a thinning amount of the lid body 3. Further, weight reduction of the cylinder apparatus can be achieved.

In addition, the length dimension H1 of the first annular protrusion 16 is set to be larger than the length dimension H2 of the second annular protrusion 17 by the dimension ΔH. Thus, when the rod guide 9 is pressed from inside, the load applied in this case can be supported with the caulked portion 1A of the outer cylinder 1 through intermediation of the lid body 3 from the first annular protrusion 16.

Meanwhile, the oil storage chamber 15 is provided between the rod guide 9 and the rod seal 11, and hence the oil liquid having leaked out from inside the inner cylinder 4 through the rod guide 9 can be stored in the oil storage chamber 15. Further, the oil liquid stored in the oil storage chamber 15 is allowed to flow to the reservoir chamber A through the second communication paths 17A, the annular space 18, and the first communication paths 9E while the lip seal (check valve) 13 is opened. Meanwhile, the lip seal 13 prevents gas and the oil liquid from reversely flowing from the reservoir chamber A into the oil storage chamber 15.

Still further, the lip seal 13 is formed integrally with the rod seal 11, and hence both the rod seal 11 and the lip seal 13 can be provided by a single molding process.

In addition, the second annular protrusion 17 is arranged at the position adjacent to the recessed portion 9D on the radially innermost side of the protrusion-formation portion 9C of the rod guide 9. With this structure, the radially inner side 3B of the lid body 3 can be reliably supported by the second annular protrusion 17, and plastic deformation of the lid body 3 is prevented. Further, the rod seal 11 is interposed between the second annular protrusion 17 and the lid body 3, and hence backlash in the axial direction can be absorbed.

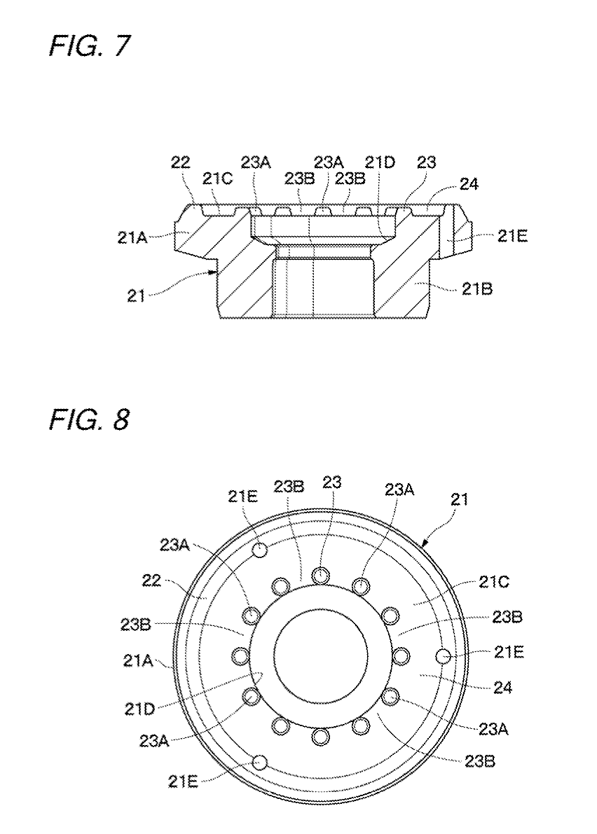

Next, FIGS. 7 and 8 illustrate a second embodiment of the present invention. This embodiment has such a feature that the second annular protrusion is formed of a plurality of annularly arranged protrusions. Note that, in this embodiment, the same components as those in the above-mentioned first embodiment are denoted by the same reference numerals, and description thereof is omitted.

In FIGS. 7 and 8, reference numeral 21 denotes a cylindrical rod guide according to the second embodiment provided on the upper end side of the inner cylinder 4. Substantially as in the case of the rod guide 9 according to the first embodiment, the rod guide 21 includes a large diameter portion 21A, a small diameter portion 21B, a protrusion-formation portion 21C, a recessed portion 21D, and first communication paths 21E. A first annular protrusion 22 and second annular protrusion 23 described later are formed coaxially in the protrusion-formation portion 21C.

Reference numeral 22 denotes the first annular protrusion according to the second embodiment provided on a radially outer side of the protrusion-formation portion 21C of the rod guide 21. The first annular protrusion 22 is formed as an annular protrusion having a length dimension in the axial direction substantially equal to that of the first annular protrusion 16 according to the first embodiment and a trapezoidal shape in cross-section.

Reference numeral 23 denotes the second annular protrusion according to the second embodiment provided on a radially inner side of the protrusion-formation portion 21C of the rod guide 21. The second annular protrusion 23 is provided on the radially inner side relative to the first annular protrusion 22 while being separated therefrom. Further, the second annular protrusion 23 support the radially inner side 3B of the lid body 3 when the lid body 3 is pressed from above. In addition, the second annular protrusion 23 are arranged at radially innermost positions of the protrusion-formation portion 21C which are adjacent to the recessed portion 21D.

In this context, the second annular protrusion 23 include a plurality of circular protrusions 23A provided in a manner of protruding to the lid body 3, the circular protrusions 23A being annularly arranged at circumferential intervals so as to constitute one annular protrusion. Further, gaps between the circular protrusions 23A constitute second communication paths 23B for communicating the oil storage chamber 15 and an annular space 24 between the annular protrusions 22 and 23 to each other. In addition, a length dimension in the axial direction of the second annular protrusion 23 is substantially equal to the length dimension in the axial direction of the second annular protrusion 17 according to the first embodiment. In other words, the length dimension in the axial direction of the second annular protrusion 23 is set to be smaller than the length dimension in the axial direction of the first annular protrusion 22.

In this manner, also in the structure of the second embodiment described above, it is possible to obtain functions and advantages substantially similar to those of the above-mentioned first embodiment. In particular, according to the second embodiment, path areas of the second communication paths 23B can be increased, and hence the oil liquid or the like having leaked out into the oil storage chamber 15 is allowed to efficiently flow to the reservoir chamber A.

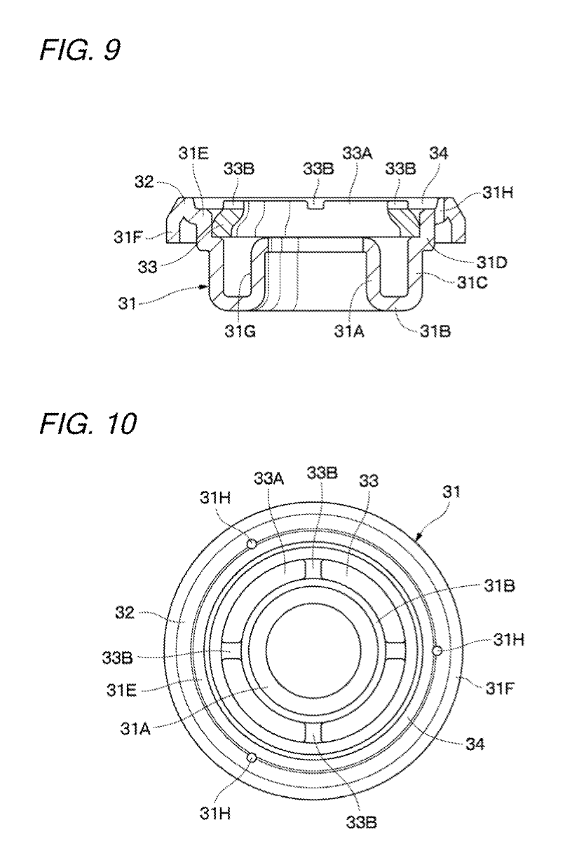

Next, FIGS. 9 and 10 illustrate a third embodiment of the present invention. This embodiment has a feature in that a rod guide is formed by a press forming process with use of a metal material. Note that, in this embodiment, the same components as those in the above-mentioned first embodiment are denoted by the same reference symbols, and description thereof is omitted.

In FIGS. 9 and 10, reference numeral 31 denotes a cylindrical rod guide according to the third embodiment provided on the upper end side of the inner cylinder 4. The rod guide 31 has functions substantially the same as those of the rod guide 9 according to the first embodiment. However, the rod guide 31 according to the third embodiment is different from the rod guide 9 according to the first embodiment in the point of being formed of a metal plate such as a steel plate or an aluminum plate subjected to, for example, a press forming process.

That is, the rod guide 31 includes: an inner cylindrical portion 31A loosely fitted onto the outer peripheral side of the piston rod 7; a radially-expanded lower portion 31B provided by radial expansion of a lower end portion of the inner cylindrical portion 31A; an intermediate cylindrical portion 31C provided upward in an extended manner from a radially outer end of the radially-expanded lower portion 31B; a radially-expanded stepped portion 31D provided at an upper end portion of the intermediate cylindrical portion 31C; a radially-expanded upper portion 31E provided by radial expansion of an upper end portion of the radially-expanded stepped portion 31D; and an outer cylindrical portion 31F provided downward in an extended manner from a radially outer end of the radially-expanded upper portion 31E. Further, a recessed portion 31G is formed between the inner cylindrical portion 31A and the intermediate cylindrical portion 31C. Still further, in the radially-expanded upper portion 31E, there are provided, for example, three first communication paths 31H for communicating an annular space 34 described later and the reservoir chamber A to each other.

In the rod guide 31, the intermediate cylindrical portion 31C and the outer cylindrical portion 31F are fixed by press-fitting to the inner peripheral side of the inner cylinder 4 and the inner peripheral side of the outer cylinder 1, respectively. Further, the lip seal 13 is brought into contact with an upper surface of the radially-expanded upper portion 31E, and a first annular protrusion 32 described later is provided on a radially outer side thereof. Meanwhile, a second annular protrusion 33 described later is fixed to the radially-expanded stepped portion 31D, and the guide portion 10 is fixed by fitting onto an inner peripheral side of the inner cylindrical portion 31A.

Reference numeral 32 denotes the first annular protrusion according to the third embodiment provided integrally with the radially outer side of the radially-expanded upper portion 31E of the rod guide 31. The first annular protrusion 32 is formed integrally as an annular protrusion having a length dimension in the axial direction substantially equal to that of the first annular protrusion 16 according to the first embodiment and a trapezoidal shape in cross-section.

Reference numeral 33 denotes the second annular protrusion according to the third embodiment provided to the rod guide 31 while being on the radially inner side relative to the first annular protrusion 32 and separated therefrom. The second annular protrusion 33 is formed as a short cylindrical body formed of a separate member, and has a lower end portion fixed onto an inner peripheral side of the radially-expanded stepped portion 31D by means such as press fitting, welding, bonding, or screwing. Meanwhile, an upper end portion of the second annular protrusion 33 protrudes upward relative to the upper surface of the radially-expanded upper portion 31E. A protruding portion 33A protruding upward relative to the upper surface of the radially-expanded upper portion 31E Supports the radially inner side 3B of the lid body 3 from below. Further, a length dimension in the axial direction of the protruding portion 33A is substantially equal to the length dimension in the axial direction of the second annular protrusion 17 according to the first embodiment. In other words, the length dimension in the axial direction of the second annular protrusion 33 (protruding portion 33A) is set to be smaller than the length dimension in the axial direction of the first annular protrusion 32.

Still further, in the second annular protrusion 33, second communication paths 33B are provided at, for example, four points in a circumferential direction of the protruding portion 33A. The second communication paths 33B communicate an oil storage chamber (not shown) and the annular space 34 between the annular protrusions 32 and 33 to each other.

In this manner, also in the structure of the third embodiment described above, it is possible to obtain functions and advantages substantially similar to those of the above-mentioned first embodiment. In particular, according to the third embodiment, the rod guide 31 is formed of a metal plate such as a steel plate or an aluminum plate subjected to, for example, a press forming process. Thus, weight reduction of the rod guide 31 can be achieved, and the rod guide 31 can be manufactured at low cost.

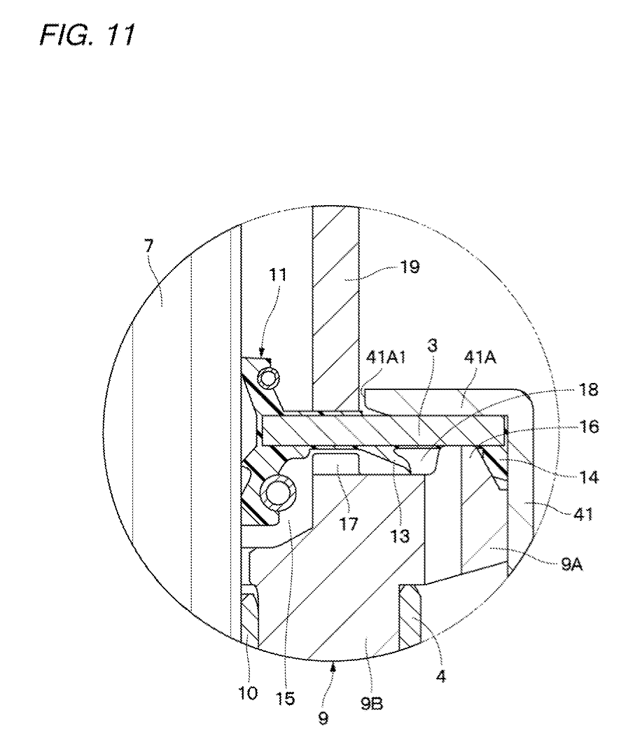

Note that, the first embodiment exemplifies a case where, in order to achieve weight reduction and cost reduction, the distal end portion 1A1 of the caulked portion 1A of the outer cylinder 1 is arranged at least at the position at which the radially outer side 3A of the lid body 3 can be sandwiched between the distal end portion 1A1 and the first annular protrusion 16. However, the present invention is not limited thereto. For example, as in the case of an outer cylinder 41 according to a modification illustrated in FIG. 11, a caulked portion 41A may be extended to a vicinity of the second annular protrusion 17. As just described, although it is preferred that the caulked portion 41A have a distal end portion 41A1 arranged on the radially outer side relative to the second annular protrusion 17, it is only necessary that the radially smallest portion 41A1 at the distal end of the caulked portion 41A be arranged on an outer side relative to an innermost diameter of the second annular protrusion 17. Note that, the distal end 41A1 of the caulked portion 41A has to be arranged so as not to interfere with the presser 19. This structure is similarly applicable to other embodiments.

Further, the first embodiment exemplifies a case where the lip seal 13 is provided as a check valve on a lower surface side of the lid body 3, and the oil liquid or the like passing through the annular space 18 is communicated and blocked with the lip seal 13. However, the present invention is not limited thereto. For example, the check valve may be provided to the rod guide 9. Specifically, the check valve may be provided so as to open and close openings of the first communication paths 9E on the reservoir chamber A side. This structure is similarly applicable to other embodiments.

Still further, the first embodiment describes that the lip seal 13 as a check valve and the seal ring 14 are formed integrally with the rod seal 11. However, the present invention is not limited thereto. For example, the rod seal 11, the lip seal 13, and the seal ring 14 may be provided separately from each other, and separately fixed to the lid body 3. This structure is similarly applicable to other embodiments.

Yet further, although the oil storage chamber 15 is provided between the rod guide 9 and the rod seal 11, this should not be construed restrictively. For example, the oil storage chamber 15 may be provided between the lid body 3 and the rod seal 11. Further, the rod guide 9 may be constituted by a plurality of members.

Yet further, although the above-mentioned embodiments describe an example of entire circumferential caulking, this should not be construed restrictively. Another end (opening end) of the outer cylinder may be partially caulked at four points in the circumferential direction. In this case, it is only necessary that innermost diameters of uncaulked portions be on a radially outer side relative to a radially inner side of the second annular protrusion.

Yet further, although the above-mentioned embodiments exemplify a cylinder apparatus fixed to an automobile, the present invention is not limited thereto. For example, the present invention may be used as a cylinder apparatus used for various machines and constructions as vibration sources, and the like.

As described in the above-mentioned embodiments, according to the embodiments of the present invention, when the another end side (opening side) of the outer cylinder is caulked, the first annular protrusion provided to the rod guide is allowed to sandwich and fixedly support the radially outer side of the lid body between the first annular protrusion and the caulked portion thereof.

In addition, although the lid body is being strongly pressed to the rod guide at the time of caulking the another end side (opening side) of the outer cylinder, the pressing force acting onto the lid body at this time can be received by the second annular protrusion provided to the rod guide while being on the radially inner side relative to the first annular protrusion and separated therefrom. As a result, the radially inner side of the lid body is prevented from being permanently deformed. In other words, the lid body is supported at two points of the first and second annular protrusions at the time of a caulking process, and hence it is possible to set a thickness dimension of the lid body to be small. Further, the distal end of the caulked portion formed by the caulking process is arranged on the radially outer side relative to the second annular protrusion. Thus, when the second annular protrusion is arranged so as to face the presser for pressing the lid body, the distal end of the caulked portion is prevented from interfering with the presser.

As a result, the lid body provided on the another end side (opening side) of the outer cylinder can be formed to have a small thickness dimension. Accordingly, the axial dimension of the cylinder apparatus can be reduced. Further, weight reduction of the cylinder apparatus can be achieved.

Further, according to one embodiment of the present invention, the length dimension in the axial direction of the first annular protrusion is set to be larger than the length dimension in the axial direction of the second annular protrusion. Thus, when the rod guide is pressed from inside, the load applied in this case can be supported with the caulked portion of the outer cylinder a high-strength member through intermediation of the lid body from the first annular protrusion.

Still further, according to one embodiment of the present invention, the oil storage chamber is provided between the rod guide and the rod seal, and hence the oil liquid having leaked out from inside the inner cylinder through the rod guide can be stored in the oil storage chamber. In addition, the oil liquid stored in the oil storage chamber is allowed to flow to the reservoir chamber while the check valve is opened. Meanwhile, the check valve prevents fluid from reversely flowing from the reservoir chamber into the oil storage chamber.

Yet further, according to one embodiment of the present invention, the reservoir chamber and the oil storage chamber can be communicated to each other through intermediation of the first communication paths, the annular space, and the second communication paths. On this premise, the check valve provided in the annular space allows the oil liquid in the oil storage chamber to flow to the reservoir chamber and prevents the reverse flow.

Yet further, according to one embodiment of the present invention, the rod seal and the check valve can be formed integrally with each other, and hence both the rod seal and the check valve can be provided by, for example, a single molding process.

Yet further, according to one embodiment of the present invention, the second annular protrusion is arranged at the position adjacent to the recessed portion on the radially innermost side of the protrusion-formation portion of the rod guide. Thus, the radially inner side of the lid body can be reliably supported by the second annular protrusion.

According to one embodiment of the present invention, the axial dimension of the cylinder apparatus can be reduced.

Although only some exemplary embodiments of this invention have been described in detail above, those skilled in the art will readily appreciate that many modifications are possible in the exemplary embodiments without materially departing from the novel teaching and advantages of this invention. Accordingly, all such modifications are intended to be included within the scope of this invention.

The present application claims priority to Japanese Patent Application No. 2009-200606 filed on Aug. 31, 2009. The entire disclosure of Japanese Patent Application No. 2009-200606 filed on Aug. 31, 2009 including specification, claims, drawings and summary is incorporated herein by reference in its entirety.

What is claimed is:

1. A cylinder apparatus, comprising:
an outer cylinder including a first end portion and a second end portion, being closed on a first-end-portion side, and being opened on a second-end-portion side;
an annular lid body provided so as to close an opening on the second-end-portion side of the outer cylinder;
an inner cylinder provided in the outer cylinder to form an annular reservoir chamber between the inner cylinder and the outer cylinder;
a piston rod having one end side inserted into the inner cylinder and having another end side protruding to an outside from the outer cylinder through the annular lid body;
a cylindrical rod guide provided on the second-end-portion side in the inner cylinder, for slidably guiding the piston rod; and
a rod seal provided on a radially inner side of the annular lid body, for sealing the piston rod by being held in sliding contact with an outer peripheral side of the piston rod, the outer cylinder including a distal end on the second-end-portion side constituting a caulked portion by being subjected to a caulking process inward to the annular lid body,
wherein the cylindrical rod guide has a surface which faces the annular lid body and on which a first annular protrusion for supporting a radially outer side of the annular lid body and a second annular protrusion for supporting the radially inner side of the annular lid body are provided, the first annular protrusion being provided at a position corresponding to the caulked portion, the second annular protrusion being provided on the radially inner side relative to the first annular protrusion while being separated from the first annular protrusion.

2. A cylinder apparatus according to claim 1, wherein the first annular protrusion has a height dimension in an axial direction larger than a height dimension in the axial direction of the second annular protrusion.

3. A cylinder apparatus according to claim 1, further comprising:
an oil storage chamber provided between the cylindrical rod guide and the rod seal, for storing oil liquid having leaked out from an inside of the inner cylinder through the cylindrical rod guide; and
a check valve provided between the oil storage chamber and the annular reservoir chamber, for allowing the oil liquid in the oil storage chamber to flow to the annular reservoir chamber and preventing a reverse flow.

4. A cylinder apparatus according to claim 2, further comprising:
an oil storage chamber provided between the cylindrical rod guide and the rod seal, for storing oil liquid having leaked out from an inside of the inner cylinder through the cylindrical rod guide; and
a check valve provided between the oil storage chamber and the annular reservoir chamber, for allowing the oil liquid in the oil storage chamber to flow to the annular reservoir chamber and preventing a reverse flow.

5. A cylinder apparatus according to claim 3,
wherein the cylindrical rod guide comprises:
a first communication path for communicating the annular reservoir chamber to an annular space formed between the first annular protrusion and the second annular protrusion; and
a second communication path for communicating the oil storage chamber and the annular space to each other, and
wherein the check valve is provided in the annular space.

6. A cylinder apparatus according to claim 4,
wherein the cylindrical rod guide comprises:
a first communication path for communicating the annular reservoir chamber to an annular space formed between the first annular protrusion and the second annular protrusion; and
a second communication path for communicating the oil storage chamber and the annular space to each other, and
wherein the check valve is provided in the annular space.

7. A cylinder apparatus according to claim 3, wherein the check valve is formed integrally with the rod seal.

8. A cylinder apparatus according to claim 4, wherein the check valve is formed integrally with the rod seal.

9. A cylinder apparatus according to claim 5, wherein the check valve is formed integrally with the rod seal.

10. A cylinder apparatus according to claim 6, wherein the check valve is formed integrally with the rod seal.

11. A cylinder apparatus according to claim 1,
wherein the surface of the cylindrical rod guide, which faces the annular lid body, comprises:
a protrusion-formation portion on which the first annular protrusion and the second annular protrusion are provided; and
a recessed portion, which is positioned on a radially inner side relative to the protrusion-formation portion and recessed in an axial direction to accommodate the rod seal, thereby constituting an oil storage chamber, and
wherein the second annular protrusion is arranged at a position adjacent to the recessed portion.

12. A cylinder apparatus according to claim 2,
wherein the surface of the cylindrical rod guide, which faces the annular lid body comprises:
a protrusion-formation portion on which the first annular protrusion and the second annular protrusion are provided; and
a recessed portion, which is positioned on a radially inner side relative to the protrusion-formation portion and recessed in the axial direction to accommodate the rod seal, thereby constituting an oil storage chamber, and
wherein the second annular protrusion is arranged at a position adjacent to the recessed portion.

13. A cylinder apparatus according to claim 3,
wherein the surface of the cylindrical rod guide, which faces the annular lid body comprises:
a protrusion-formation portion on which the first annular protrusion and the second annular protrusion are provided; and
a recessed portion, which is positioned on a radially inner side relative to the protrusion-formation portion and recessed in an axial direction to accommodate the rod seal, thereby constituting the oil storage chamber, and
wherein the second annular protrusion is arranged at a position adjacent to the recessed portion.

14. A cylinder apparatus according to claim 4,
wherein the surface of the cylindrical rod guide, which faces the annular lid body comprises:
a protrusion-formation portion on which the first annular protrusion and the second annular protrusion are provided; and
a recessed portion positioned on a radially inner side relative to the protrusion-formation portion and recessed in the axial direction to accommodate the rod seal, thereby constituting the oil storage chamber, and
wherein the second annular protrusion is arranged at a position adjacent to the recessed portion.

15. A cylinder apparatus according to claim 5,
wherein the surface of the cylindrical rod guide, which faces the annular lid body comprises:
a protrusion-formation portion on which the first annular protrusion and the second annular protrusion are provided; and
a recessed portion, which is positioned on a radially inner side relative to the protrusion-formation portion and recessed in an axial direction to accommodate the rod seal, thereby constituting the oil storage chamber, and
wherein the second annular protrusion is arranged at a position adjacent to the recessed portion.

16. A cylinder apparatus according to claim 6,
wherein the surface of the cylindrical rod guide, which faces the annular lid body comprises:
a protrusion-formation portion on which the first annular protrusion and the second annular protrusion are provided; and
a recessed portion, which is positioned on a radially inner side relative to the protrusion-formation portion and recessed in the axial direction to accommodate the rod seal, thereby constituting the oil storage chamber, and
wherein the second annular protrusion is arranged at a position adjacent to the recessed portion.

17. A cylinder apparatus according to claim 1, wherein a radially smallest portion at a distal end of the caulked portion is positioned on an outer side relative to an inner diameter of the second annular protrusion.

18. A cylinder apparatus according to claim 2, wherein a radially smallest portion at a distal end of the caulked portion is positioned on an outer side relative to an inner diameter of the second annular protrusion.

19. A cylinder apparatus according to claim 3, wherein a radially smallest portion at a distal end of the caulked portion is positioned on an outer side relative to an inner diameter of the second annular protrusion.

20. A cylinder apparatus according to claim 4, wherein a radially smallest portion at a distal end of the caulked portion is positioned on an outer side relative to an inner diameter of the second annular protrusion.
